(19) United States
(12) Patent Application Publication
(10) Pub. No.: US 2019/0324621 A1
(43) Pub. Date: Oct. 24, 2019

(54) System and Methods for Utilizing Multi-Finger Touch Capability to Efficiently Perform Content Editing on a Computing Device

(71) Applicant: QUALCOMM Incorporated, San Diego, CA (US)

(72) Inventor: Mohan Maiya, San Jose, CA (US)

(21) Appl. No.: 15/959,787

(22) Filed: Apr. 23, 2018

(51) Int. Cl. G06F 3/0488; G06F 3/0484; G06F 3/041; G06F 17/24; G06F 3/0481

(52) U.S. Cl. CPC G06F 3/0488; G06F 3/04842; G06F 3/041; G06F 2203/04808; G06F 3/04817; G06F 2203/04104; G06F 17/24

(57) ABSTRACT

Various embodiments include methods utilizing a touch-sensitive user interface of a computing device. Various embodiments may include identifying a characteristic of a first touch event (e.g., a number of contacting fingers) triggering a function that stores or selects a data object in memory, mapping a selected data object to an index value associated with the identified number of fingers, detecting a second user input touch event triggering a second function (e.g., an editing function) that uses a stored data object, determining whether the characteristic of the second touch event, such as a number of contacting fingers, matches an index value mapped to a previously stored data object, and performing the triggered editing action using the data object mapped to the index value in response to determining that the characteristic (e.g., number of contacting fingers) of the second touch event matches an index value mapped to a previously stored data object.

### BACKGROUND

Current computing devices include advanced input systems, such as touchscreen interfaces, and often employ universal shortcuts across various applications. Such shortcuts may include keystroke sequences, designated virtual button, etc., and are often implemented for editing functions within various text, image, video, or audio editing applications. For example, many computing devices employ a designated keystroke sequence to trigger cut, copy, and paste functionality with respect to selected content from a source file. Such a keystroke sequence is efficient as the user can avoid the longer input process of opening an editing menu and selecting the “cut,” “copy,” or “paste” function.

Smartphones and similar computing devices that are configured with touchscreens (e.g., tablets, laptop etc.) are capable of detecting and distinguishing various touch inputs, including multi-finger touches, which expands the number of possible user inputs and combinations that may be programmed as shortcuts. However, the editing functions that are typically associated with such shortcuts are only capable of handling a single selected object at a time (e.g., a most recent selection from a source file). This can result in user inefficiencies in some situations.

### SUMMARY

Systems, methods, and devices of various embodiments may enable a computing device configured with a touch-sensitive user interface or other touch-sensitive user interface to utilize multi-finger touch input capability to enable performing functions using more than one data object at a time. Various embodiments may include detecting on the touch-sensitive user interface a characteristic of a first touch event of a user input triggering a first function to be performed on a data object, mapping the data object selected by the user to an index value based on the characteristic of the first touch event, detecting on the touch-sensitive user interface the characteristic of a second touch event of a user input triggering a second function, determining whether the characteristic of the second touch event matches the characteristic of the first touch event, and performing the second function using the data object mapped to the index value based on the characteristic of the second touch event in response to determining that the characteristic of the second touch event matches the characteristic of the first touch event. In some embodiments, the data object may include at least one of text, image data, video data, or audio data selected by a user.

In some embodiments, the characteristic is a number of fingers touching the touch-sensitive user interface. In such embodiments, detecting on the touch-sensitive user interface a characteristic of a first touch event of a user input triggering a first function to be performed on a data object may include detecting a first touch event of a user input that selects the data object, in which the first function stores the selected data object in memory. In such embodiments, mapping the data object selected by the user to an index value based on the characteristic of the first touch event may include identifying a number of fingers contacting the touch-sensitive user interface during the first touch event, and mapping the data object to an index value associated with the identified number of fingers contacting the touch-sensitive user interface during the first touch event. In such embodiments, determining whether the characteristic of the second touch event matches the characteristic of the first touch event may include determining whether a number of fingers contacting the touch-sensitive user interface during the second touch event matches the index value to which the data object is mapped. In such embodiments, detecting on the touch-sensitive user interface the characteristic of a second touch event of a user input triggering a second function may include detecting a user input triggering an editing action using a stored data object indexed to a number of fingers contacting the touch-sensitive user interface in the second touch event. In such embodiments, identifying a number of fingers contacting the touch-sensitive user interface during the first touch event may include identifying a number of adjacent fingers contacting the touch-sensitive user interface during the first touch event, and determining whether a number of fingers contacting the touch-sensitive user interface during the second touch event matches the index value to which the data object is mapped may include determining whether a number of adjacent fingers contacting the touch-sensitive user interface during the second touch event matches the index value to which the data object is mapped.

In some embodiments, performing the second function using the data object mapped to the index value based on the characteristic of the second touch event may include accessing a buffer corresponding to the index value, and retrieving the data object stored in the buffer.

In some embodiments, mapping the data object to an index value based on the characteristic of the first touch event on the touch-sensitive user interface may include identifying a location in memory storing the selected data object, and storing a pointer indicating a start of the location in memory and a size of the selected data object in a register corresponding to the index value. In such embodiments, performing the second function using the data object mapped to the index value based on the characteristic of the second touch event may include accessing the register corresponding to the index value, and locating the data object in memory based on the pointer and size stored in the register corresponding to the index value.

Some embodiments may further include activating a touch selection functionality in a content editing application in response to detecting a user input launching an editing menu in the content editing application.

In some embodiments, the data object may be selected from a source file by a user, and the triggered second function may be performed on a target file that is different from the source file.

In some embodiments, performing the second function using the data object mapped to the index value based on the characteristic of the second touch event may include identifying a triggered editing action based on the second touch event, in which identification may be based on at least one of a location on the touch-sensitive user interface relative to a GUI element and a gesture on the touch-sensitive user interface during the second touch event.

In some embodiments, when the triggered second function is an insert operation, performing the second function using the data object mapped to the index value based on the characteristic of the second touch event may include adding the data object mapped to the index value to an existing file at a position indicated by the user.

Various embodiments include a computing device including a touch-sensitive user interface or other touch-sensitive user interface, and a processor configured with processor-executable instructions to perform operations of any of the methods summarized above. Various embodiments include a non-transitory processor-readable medium on which is stored processor-executable instructions configured to cause a processor of a computing device to perform operations of any of the methods summarized above. Various embodiments include a computing device having means for performing functions of any of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the claims.

FIG. 1 is a block diagram illustrating a smartphone device suitable for use with various embodiments.

FIG. 2 is a block diagram illustrating an example system for implementing multi-finger touch input on a device according to various embodiments.

FIGS. 3A-3F are illustrations of an example mobile computing device showing multi-finger touch input used to implement an editing function according to various embodiments.

FIG. 4 is a process flow diagram illustrating an example method for implementing multi-finger touch mapping for a content editing application on a smartphone according to various embodiments.

### DETAILED DESCRIPTION

The various embodiments will be described in detail with reference to the accompanying drawings. Wherever possible, the same reference numbers will be used throughout the drawings to refer to the same or like parts. References made to specific examples and implementations are for illustrative purposes, and are not intended to limit the scope of the claims.

The terms “editing function” and “editing functionality” may be used interchangeably herein to refer to the selection of a data object, and performance of an action or operation upon the selected data object, within a content editing application action or operation.

The term “content editing application” as used herein may refer to any application in which content of a document or file can be manipulated through user input, such as by adding new content, or selecting, modifying, moving, copying, or removing existing content, or in which documents or files can be collected or stored by a user. The terms “source document” or “source file” as used herein may refer to any selectable information that can be displayed or otherwise presented to a user. The term “target document” or “target file” as used herein may refer to any modifiable data or information that can be displayed or otherwise presented to a user, and may be same as or different from the source document. For example, in various embodiments, a data object may be selected and copied from a source file and inserted into the target file.

Systems, methods, and devices of various embodiments utilize the multi-finger touch-sensitive user interface capability of mobile devices to provide greater functionality by enabling different user inputs to be mapped to different data objects for use in various functions. Various embodiments include detecting a touch event characteristic (e.g., the number and locations of fingers engaging the touch-sensitive user interface), mapping a data object selected by the user to an index value based on the detected characteristic of the touch event, detecting the characteristic of a second touch event of a user input triggering a second function, and performing the second function using the data object mapped to the index value based on the detected characteristic of the second touch event. In some embodiments, the first and second functions may be editing functions, and various embodiments provide content editing shortcuts for multiple data objects that enable simultaneous manipulation of a variety of content elements based on the characteristic of the touch events. In some embodiments, when a user editing input is received, the computing device notes the number of fingers (i.e., the characteristic) touching the touch-sensitive user interface (e.g., a touchscreen or touch pad) during the input, and the number of fingers touching the touch-sensitive user interface may be associated with different respective objects to which an editing function is applied or performed. For example, the number of fingers touching a “copy” or “paste” menu icon on a configured to function as a user interface may be used by the computing device to assign an identifier to each copied selection. This enables a user to copy or cut a number of objects without pasting the selection, and then paste particular objects into a file by touching the user interface with the number of fingers associated with a selected object. Objects may be copied/cut and pasted in any order identified by the user based on the number finger touches touching an editing icon. While descriptions of various embodiments may refer to “copy” and “paste” functions, various embodiments may be implemented for any editing function that involves performing an action on a user-selected object via a multi-finger touch-sensitive user interface. Thus, the various embodiments improve upon current user interfaces systems by extending functions to multiple objects that the user identifies based upon a characteristic of touch events, such as the number of fingers touching the user interface when a function icon is touched. While example embodiments are described with reference to a touchscreen type of touch-sensitive user interface, various embodiments are not limited implementations using touchscreens, and may be implemented on any computing device using or equipped with a multi-finger touch-sensitive user interface including touch pads.

Various operations or functions are commonly available to users editing a file on a computing device, which may be implemented by a copy-paste or cut-paste mechanism. For example, during a cut operation, the cut-paste mechanism typically removes information selected by the user from displayed information and places this selected information into a buffer. During a copy operation, the copy-paste mechanism copies (but does not remove) the information selected by the user in the displayed information, and places this selected information into the buffer. Both the cut and copy operations are typically followed by a paste operation, which inserts the copied information in the buffer into a target file at an indicated position.

Editing operations or functions employed in content editing applications, such as cut-paste and copy-paste function sequences, typically use a block of scratchpad memory that operates as a buffer for temporary storage of a user-selected object data. The buffer may be provided as a clipboard, with data that is written to the clipboard available to be moved, copied, or otherwise used in another location within memory. Data may be accumulated in the clipboard in a first operation (e.g., copy or cut), after which the data in the clipboard may be written to another file in a second operation (e.g., paste). When another data object is copied or cut, that data is stored in the clipboard overwriting any data previously stored in the buffer in a last-in first-out (LIFO) manner A sector of the scratch pad memory that is used as the clipboard may be identified by marking to enable easy identification by a controller. Further, an index of the data stored in the clipboard may be maintained, which may be updated for each change in the buffer of the clipboard. For example, a clipboard that is configured to hold a circular buffer may employ a head pointer that stores the address of (i.e., “points to”) the start of the data object, and either a tail pointer that points to the end of the data object in the buffer or an integer indicating the amount of size of the data object currently in the buffer.

Various embodiments extend the functionality of a clipboard-type buffer by accommodating multiple objects, with each object indexed based on a characteristic of the touch event, such as the number of fingers touching the user interface when each object was selected by a copy or cut operation. Various embodiments thus enable certain objects to be overwritten by a subsequent copy/cut operation based on the characteristic of the touch event, such as the number of fingers touching the user interface when the subsequent object was selected without overwriting other objects stored in the clipboard or buffer. In some embodiments, the clipboard buffer may allow for temporary storage of data that is intended to be written to another application, while in some embodiments the temporarily stored data may be inserted into a target file using the same application. In some embodiments, the operating system may provide storage for the data object selected for the editing operation.

As an example, a user may activate an editing function on a computing device touch-sensitive user interface, for example, by making a specific input (e.g., cursor selection, tapping, etc.) to the touch-sensitive user interface representing editing functionality within a content editing application. In some embodiments, the specific input may be on a touchscreen, and may involve an action (e.g., cursor selection, tapping, etc.) to a representative GUI element. In some embodiments, the specific input may be a voice command (e.g., speaking to an intelligent interface on the device). In some embodiments, editing functionality may be automatically activated when the user is interacting with a content editing application.

Once the editing functionality is activated, input to the user interface (e.g., a touchscreen) may include a multi-finger touch gesture for example (e.g., using 1-5 fingers simultaneously). Other types of interactions with different characteristics may also be used in various embodiments. In this example, the computing device determines the number of fingers touching the user interface in the gesture, and maps a selected content element within a source file (sometimes referred to herein as a data object) to the number of fingers. This creates a touch-correlated selection. In some embodiments, the particular content element and resulting touch correlated selection may be data or a data object that has been selected or highlighted by the user, such as through input via a cursor, trackpad, keystroke, touchscreen, etc. In various embodiments, a function, such as an editing action or operation, may be performed by a user on a touch correlated selection by inputting a gesture or selecting a tool using the corresponding characteristic, such as the number of fingers correlated with the data or data object. In this manner, various embodiments enable the user to perform an action, function or operation with respect to any of multiple different data objects (e.g., text, image, audio, video, etc.) that are selected from one or more source files based on each touch event's characteristic, such as the number of fingers touching the touch-sensitive user interface.

For example, a user of a touchscreen device, such as a smartphone, tablet, etc., may select a first data object from within a source file using normal editing operations. In a particular embodiment, for example, the source file may be a document or other file containing text, and the user may select the first data object by highlighting a first portion of the text through the touchscreen within a content editing application. The multi-touch editing functionality may be activated by the user touching a button or soft key on the touchscreen, or expanding a menu on the touchscreen, within the content editing application. Upon activation, the user may employ a multi-finger touch gesture to correlate (or map) the highlighted first portion to the number of fingers used in the multi-finger touch gesture. Such multi-finger touch gesture may be, for example, multi-finger tapping (e.g., a one-finger tap) on a “cut” or “copy” tool within the content editing application. In this manner, a one-finger touch correlated selection may be created containing the first portion of text. The user may select a second data object, such as by highlighting a second portion of text through the touchscreen. In various embodiments, the second data object may be selected from within the same source file (e.g., same document) or from a different source file.

The user may employ a new multi-finger touch gesture to correlate or map the selected portion of the text (i.e., second data object) to a different number of fingers used in the gesture. Such a new multi-finger touch gesture may be, for example, a two-finger tap on a “cut” or “copy” tool within the content editing application. In this manner, a two-finger touch correlated selection may be created containing the second portion of text. Such a creation of touch correlated selection process may be repeated with up to five (for one hand), or more (for two hands) different portions of text or other data objects, for example, thereby enabling the user to correlate or map five different objects to distinct multi-touch inputs.

Once the different touch correlated selections are created, each may be individually used in a text editing action acting on a destination file. In some embodiments, the destination file may be the same as one or more of the source files, or may be a new file. The user may employ a multi-finger touch gesture that triggers a particular text editing action associated with a data object correlated or mapped to the number of fingers touching the user interface while working within the content editing application.

Such multi-finger touch gestures may be, for example, a multi-finger tap on a “paste” tool within the content editing application. Based on the number of fingers used, the editing action may be invoked as to the associated touch correlated selection. The editing action may be a paste operation that inserts the text of the touch correlated selection into a text field or document. For example, in response to the user's input of a one-finger tap on the “paste” tool, the one-finger touch correlated selection (i.e., the first portion of text) may be inserted into the destination file at a position indicated by the user. In response to the user's input of a two-finger tap on the “paste” tool, the two-finger touch correlated selection (i.e., the second portion of text) may be inserted into the destination file. The editing action or operation may be performed in the same content editing application that was used to map one or more data objects to a multi-touch input, or may be performed in a new content editing application that employs at least some of the same editing operations and commands. In this manner, various embodiments enable the user to perform an action or operation with respect to any of multiple different data objects (e.g., text, image, audio, video, etc.) that are selected from one or more source files. In some embodiments, upon performing a particular editing action the user may be able to select whether the data object will be retained in the corresponding clipboard for reuse in another editing operation, or will be discarded after the single editing action is performed, thus freeing up the clipboard space to map other data objects.

While various embodiments are described in greater detail below using the example embodiment in which the characteristic of a multi-finger touch event is the number of fingers touching the touch-sensitive user interface, various embodiments may involve other types of touch event characteristics and function in a manner consistent with the following examples. Other non-limiting types of touch event characteristics that may be recognized and used in mapping data objects to index values include an area of the touch-sensitive user interface in contact with the user during the touch event, a length of a finger touching the touch-sensitive user interface during the touch event, an orientation of the computing device during the touch event, locations on the touch-sensitive user interface contacted during the touch event, and the like.

Properties of a user's touch input to a touchscreen of a mobile computing device may be calculated by a processor of the computing device. A processor using signals received from the user interface (e.g., a touchscreen) may calculate parameters associated with an input touch gesture, for example, position, contact area, pressure, etc. The processor may determine the characteristic of the touch event, such as the number of fingers used for the touch gesture, based at least in part on the calculated parameters. In some embodiments, the position of a cursor on the touchscreen may be calculated as a vector extending from a center point of the portion of the touchscreen touched by the finger(s). The vector may have a length or magnitude calculated based on the calculated touch pressure. The vector may have an angular orientation based on the calculated orientation of the finger. When the cursor or touch position is on a GUI element that is selectable, the GUI element may be selected by physically lifting the one or more finger off the touchscreen (i.e., away from the smartphone), thereby completing a “tap.”

Various embodiments may be used in a variety of computing device that include a touchable user interface, such as a touchscreen or touchpad. Various embodiments may be particularly useful in mobile computing devices, such as smartphones and tablet devices. Smartphones are particularly suitable for implementing the various embodiments, and therefore are used as examples in the figures and the descriptions of various embodiments. However, the claims are not intended to be limited to smartphones unless explicitly recited and encompass any mobile computing device of a size suitable for single handed use.

As used herein, the terms “smartphone device,” “smartphone,” and “mobile computing device” refer to any of a variety of mobile computing devices, such as cellular telephones, tablet computers, personal data assistants (PDAs), wearable device (e.g., watch, head mounted display, virtual reality glasses, etc.), palm-top computers, notebook computers, laptop computers, wireless electronic mail receivers and cellular telephone receivers, multimedia Internet enabled cellular telephones, multimedia enabled smartphones (e.g., Android® and Apple iPhone®), and similar electronic devices that include a programmable processor, memory, and a touchscreen display/user interface.

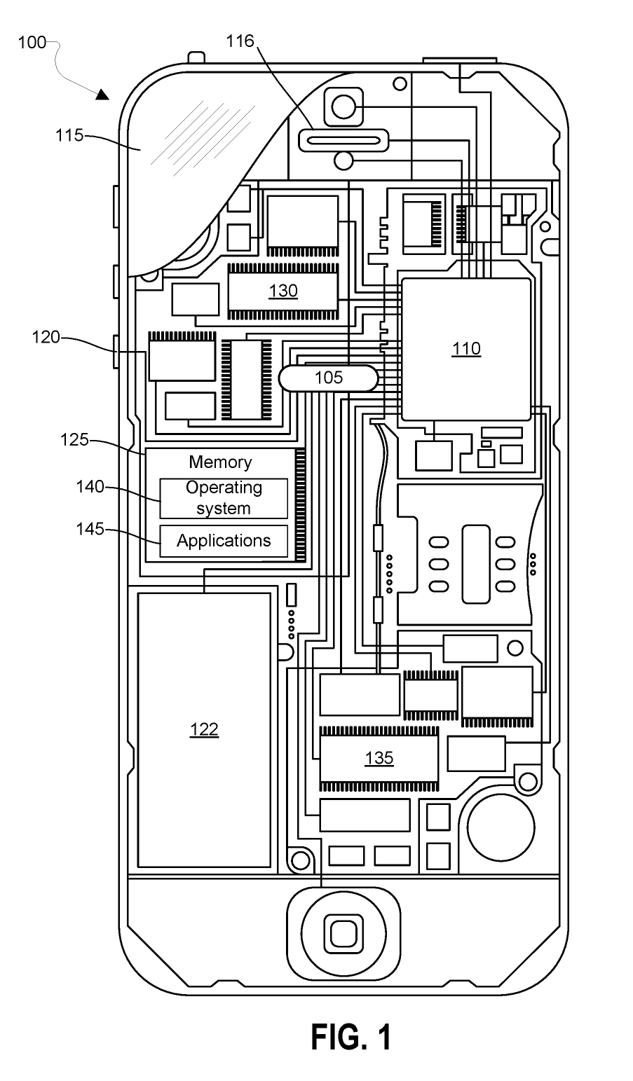

FIG. 1 is a component diagram of a mobile computing device that may be adapted for utilizing content editing applications based on multi-finger touches according to various embodiments. A smartphone device 100 is shown that includes hardware elements electrically coupled via a bus 105 (or may otherwise be in communication, as appropriate). The hardware elements may include one or more processor(s) 110, including without limitation one or more general-purpose processors and/or one or more special-purpose processors (such as digital signal processing chips, graphics acceleration processors, and/or the like), one or more input devices, such as a touchscreen 115. The hardware elements may further include without limitation a mouse, a keyboard, keypad, camera, microphone and/or the like; and one or more output devices 120, which include without limitation an interface 120 (e.g., a universal serial bus (USB)) for coupling to external output devices, a display device, a speaker 116, a printer, and/or the like.

A smartphone device 100 may further include (and/or be in communication with) one or more non-transitory storage devices 125, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

A smartphone device 100 may also include a communications subsystem 130, which can include without limitation a modem, a network card (wireless or wired), an infrared communication device, a wireless communication device and/or chipset (such as a Bluetooth device, an 802.11 device, a Wi-Fi device, a WiMAX device, cellular communication facilities, etc.), and/or the like. The communications subsystem 130 may permit data to be exchanged with a network, other devices, and/or any other devices described herein. In one embodiment, the device 100 may further include a memory 135, which may include a Random Access Memory (RAM) or Read Only Memory (ROM) device, as described above. The smartphone device 100 may be a mobile device or a non-mobile device, and may have wireless and/or wired connections.

A smartphone device 100 may include a power source 122 coupled to the processor 110, such as a disposable or rechargeable battery. The rechargeable battery may also be coupled to the peripheral device connection port to receive a charging current from a source external to the smartphone device 100.

A smartphone device 100 may also include software elements, shown as being stored within the working memory 135, including an operating system 140, device drivers, executable libraries, and/or other code, such as one or more application programs 145, which may include or may be designed to implement methods, and/or configure systems, provided by embodiments, as will be described herein. Merely by way of example, one or more procedures described with respect to the method(s) discussed below may be implemented as code and/or instructions executable by the smartphone device 100 (and/or a processor(s) 110 within the smartphone device 100). In an embodiment, such code and/or instructions may be used to configure and/or adapt a general purpose processor 120 (or other device) to perform one or more operations in accordance with the described embodiments.

A set of these instructions and/or code may be stored on a non-transitory processor-readable storage medium, such as the storage device(s) 125 described above. In some embodiments, the storage medium may be incorporated within a device, such as the smartphone device 100. In other embodiments, the storage medium may be separate from a device (e.g., a removable medium, such as a compact disc), and/or provided in an installation package, such that the storage medium can be used to program, configure, and/or adapt a general purpose computer with the instructions/code stored thereon. These instructions may take the form of executable code, which is executable by the smartphone processor 110 and/or may take the form of source and/or installable code, which, upon compilation and/or installation on the smartphone processor 110 (e.g., using any of a variety of generally available compilers, installation programs, compression/decompression utilities, etc.) then takes the form of executable code. Application programs 145 may include one or more content editing applications. The functionality of the applications may be alternatively implemented in hardware or different levels of software, such as an operating system (OS) 140, a firmware, a computer vision module, etc.

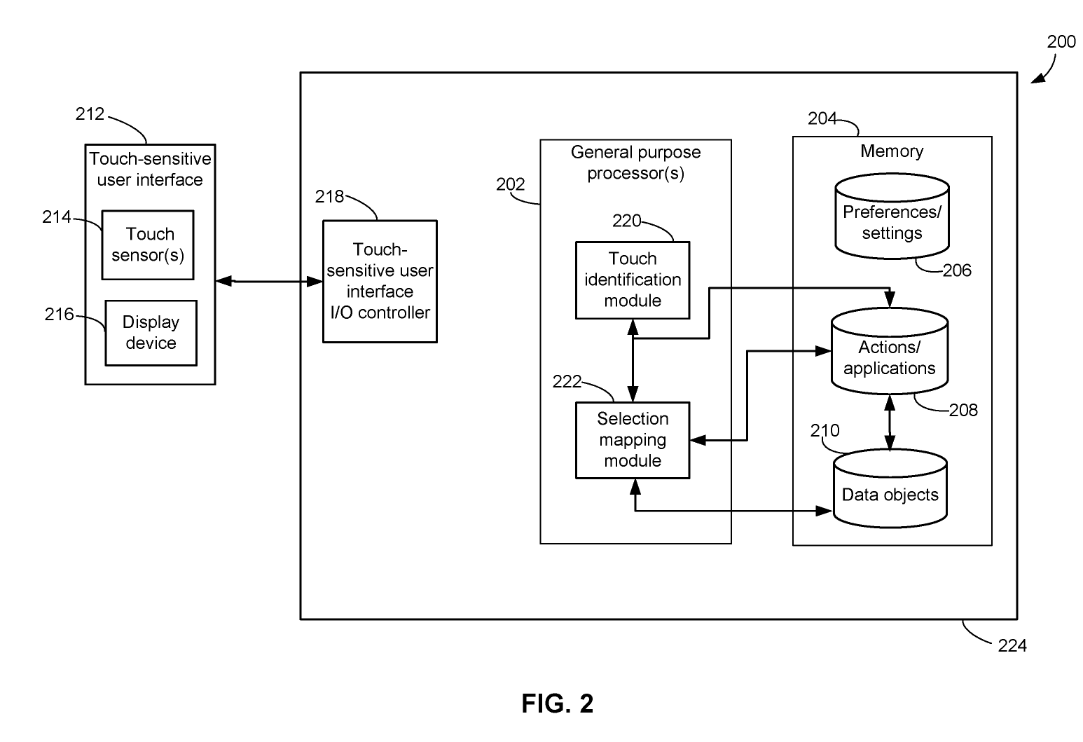

FIG. 2 is a functional block diagram of a smartphone 200 showing elements that may be used for implementing a multi-finger touch input for editing functions according to various embodiments. Referring to FIGS. 1-2, the smartphone 200 may be similar to the smartphone device 100 described with reference to FIG. 1.

As shown, the smartphone 200 includes at least one controller, such as general purpose processor(s) 202 (e.g., 110), which may be coupled to at least one memory 204 (e.g., 135). The memory 204 may be a non-transitory tangible computer readable storage medium that stores processor-executable instructions. For example, the instructions may include those for transmitting and receiving data files and/or other content though a network interface or other connection. The memory 204 may store the operating system (OS) (140), as well as user application software and executable instructions, including processor-executable instruction implementing methods of the various embodiments. The memory 204 may also store databases or other storage repositories configured to maintain information that may be used by the general purpose processor 202 for implementing content editing applications and performing related functions. Such storage may include preferences/settings 206, actions/applications 208, and data objects 210. For example, the preferences/settings 206 may be a database configured to receive and store information defined by content editing applications, collected user data, personalization preferences established by the user, etc. The applications/actions 208 may include content editing applications, as well as processor-executable instructions for performing editing actions that may be applied to data objects in the content editing applications. The data objects 210 may contain data objects that are selected or copied from a source file,

In some embodiments, the data objects 210 may be stored as part of the complete source file, while in other embodiments data objects may be written from a source file into a temporary buffer.

The smartphone 200 may also include a touch-sensitive user interface 212 (such as a touchscreen system and/or touchscreen display) that includes one or more touch sensor(s) 214 and a display device 216. The touch sensor(s) 214 may be configured to sense the touch contact caused by the user touching a touch-sensitive surface with one to five (or more) fingers. For example, the touch-sensitive surface may be based on capacitive sensing, optical sensing, resistive sensing, electric field sensing, surface acoustic wave sensing, pressure sensing and/or other technologies. In some embodiments, the touch-sensitive user interface 212 may be configured to recognize touches, as well as the position and magnitude of touches on the touch sensitive surface.

The display device 216 may be a light emitting diode (LED) display, a liquid crystal LED display (LCD) (e.g., active matrix, passive matrix), and the like. Alternatively, the display device 216 may be a monitor such as a monochrome display, color graphics adapter (CGA) display, enhanced graphics adapter (EGA) display, variable-graphics-array (VGA) display, super VGA display, cathode ray tube (CRT), and the like. The display device may also correspond to a plasma display or a display implemented with electronic inks.

In various embodiments, the display device 216 may generally be configured to display a GUI that enables interaction between a user of the computer system and the operating system or application running thereon. The GUI may represent programs, files and operational options with graphical images. The graphical images may include windows, fields, dialog boxes, menus, icons, buttons, cursors, scroll bars, etc. Such images may be arranged in predefined layouts, or may be created dynamically to serve the specific actions being taken by a user. During operation, the user may select and activate various graphical images in order to initiate functions and tasks associated therewith. By way of example, a user may select a button that opens, closes, minimizes, or maximizes a window, or an icon that launches a particular program.

The touch-sensitive user interface in various embodiments may be coupled to a user input/output (I/O) controller 218 that enables input of information from the sensor(s) 214 (e.g., touch events) and output of information to the display device 216 (e.g., GUI presentation). In various embodiments, the touch-sensitive user interface I/O controller may receive information from the touch sensor(s) 214 based on the user's touch, and may send the information to specific modules configured to be executed by the general purpose processor(s) 202 in order to interpret touch events.

In various embodiments, single point touches and multipoint touches may be interpreted. The term “single point touch” as used herein refers to a touch event defined by interaction with a single portion of a single finger (or instrument), although the interaction could occur over time. Examples of single point touch input include a simple touch (e.g., a single tap), touch-and-drag, and double-touch (e.g., a double-tap—two taps in quick succession). A “multi-point touch” may refer to a touch event defined by one finger or a combination of different fingers or finger parts. combinations of different fingers or finger parts.

In various embodiments, the smartphone may include other input/output (I/O) devices that, in combination with or independent of the touch-sensitive user interface 212, may be configured to transfer data into the smartphone. For example, the touch-sensitive user interface I/O controller 218 may be used to perform tracking and to make selections with respect to the GUI on the display device, as well as to issue commands. Such commands may be associated with zooming, panning, scrolling, paging, rotating, sizing, etc. Further, the commands may also be associated with launching a particular program, opening a file or document, viewing a menu, making a selection, executing instructions, logging onto the computer system, loading a user profile associated with a user's preferred arrangement, etc.

When touch input is received through the touch-sensitive user interface I/O controller 218, the general purpose processor 202 may implement one or more program modules to identify/interpret the touch event and control various components of the smartphone. For example, a touch identification module 220 may identify touch events, including multi-finger touch events that correspond to commands for activating various features, as well as detect characteristics of the touch events, such as the number of fingers touching the touch-sensitive user interface. For example, the touch identification module 220 may identify a multi-finger touch event and its location or context within the GUI. In some embodiments, the touch identification module 220 may recognize a multi-finger touch event as intended to create a touch correlated selection or as triggering an editing action. For example, the touch identification module 220 may detect that a user has activated an editing menu within a content editing application, has selected a content portion (i.e., data object), and that a multi-finger touch input is detected in a particular region of the touch-sensitive user interface associated with a function. For example, the particular region of the touch-sensitive user interface may correspond to a selectable soft key or link for a selecting operation (i.e., copy or cut). In some embodiments, the touch identification module 220 may also detect the number of fingers contacting the screen in a multi-finger gesture.

The general purpose processor(s) 202 may implement one or more program modules to create the multi-finger touch correlated selection. For example, a selection mapping module 222 may be configured to link a portion of content that has been selected by the user (e.g., via input using a cursor or other mechanism for selection) to an index value of the number of fingers in a multi-finger touch input. In some embodiments, the number of fingers may be a value that is passed to the selection mapping module 222 by the touch identification module 220.

The touch identification module 220 may be configured to recognize the characteristic of a touch event, such as a multi-finger touch, as intended to trigger an editing action with respect to a particular data object. For example, the touch identification module 220 may detect that a user has activated an editing menu within a content editing application, and that a multi-finger touch input is detected in a region of the touch-sensitive user interface corresponding to performing an action or operation involving content. The region of the touch-sensitive user interface may be, for example, a selectable soft key or link for a data insertion operation (i.e., paste). The touch identification module 220 may also detect the characteristic of the touch event, such as a number of fingers contacting the touch-sensitive user interface in a multi-finger gesture, which may be passed to the selection mapping module 222 to obtain the particular content portion or location thereof in memory.

In various embodiments, the touch identification module 220, the selection mapping module 222, and any other program modules implemented by the general purpose processor(s) 202 may be stored in memory 204.

The touch identification module 220 may also identify touch events that correspond to commands for performing other actions in applications stored in the memory 204, modifying GUI elements shown on the display device 218, modifying data stored in memory 204, etc. For example, cursor tracking on the device may be controlled by the user moving a single finger on a touch sensitive surface of the touch-sensitive user interface 212. Such tracking may involve interpreting touch events by the touch identifier module 220, and generating signals for producing corresponding movement of a cursor icon on the display device 216.

In various embodiments, interpreting touch events, including multi-finger touch gestures, may involve extracting features from touch data, and computing various parameters. The extracted touch data features may include, for example, a number of touches/fingers used, position and shape of touches, etc., while the computed parameters may include the touch pressure and/or size of the touch area, etc. In various embodiments, such touch data and computing parameters may be computed by the touch-sensitive user interface I/O interface 218. Other functions, including filtering signals and conversion into different formats, as well as interpreting touch events unrelated to multi-finger touch correlated selections, may be performed by a processor (e.g., the general purpose processor(s) 202 or a touch-sensitive user interface I/O controller 218), using any of a variety of additional programs/modules stored in memory 204.

In some embodiments, the general purpose processor(s) 202, memory 204, and touch-sensitive user interface I/O controller 218 may be included in a system-on-chip device 224. One or more subscriber identity modules (SIMs) and corresponding interface(s) may be external to the system-on-chip device 224, as well as various peripheral devices (e.g., additional input and/or output devices) that may be coupled to components of the system-on-chip device 224, such as interfaces or controllers.

As described, various embodiments may enable separately linking data objects to indices that correspond to a number of fingers employed in a multi-screen touch input by the user. In this manner, the user may invoke the same editing function for different data objects by using the corresponding number of fingers in a multi-finger touch input triggering the function. The editing functions that may be used in various embodiments include copy-paste and cut-paste mechanisms, which may be applied to a number of data types (e.g., text, image, audio, video, etc.) in a variety of applications (e.g., word processors, image views/editors, audio/video editors, internet browsers, PDF editors/viewers, etc.). In various embodiments, such cut-paste or copy-paste mechanisms may be utilized in a variety of content editing applications, for example, word processors, spreadsheets, image editors, video and/or audio editors, digital composers, internet browsers, file explorers, etc.

Additional editing functions beyond copy-paste and cut-paste mechanisms may also utilize multi-finger touch correlated selections. Such additional editing functions may also be applied to any of a variety of data types in a number of content editing applications, including those described with respect to cut-paste and copy-paste operations.

For example, a user may create touch correlated selections of video clips using different fingers, such as by linking a first video clip to one-finger touch input, a second video clip to two-finger touch input, up to five videos. The user may cause each of the clips to be individually added to a target video stream by performing an associated multi-finger touch gesture on the touch-sensitive user interface using the correlated number of fingers. For example, the user may select a time in the target stream in which the first video clip should be entered, and touch an “insert” GUI element or provide other touch input using one finger.

In another example, a user may create touch correlated selections of audio clips or sound effects. For example, an audio clip (e.g., sample of a song) may be linked to one-finger touch, while a sound effect (e.g., car horn, screaming sound, etc.) may be linked to a two-finger touch. In an audio editor or digital sound composer, the user may add a particular clip or effect to an audio track by performing an associated multi-finger touch gesture on the touch-sensitive user interface using the correlated number of fingers. For example, within an audio editor or digital composer application, the user may select a time in an existing target audio stream or a time within a new audio composition at which to insert the audio clip or sound effect. Within the application, the user may touch an “insert” GUI element or provide other touch input using one finger to add the audio clip, and with two fingers to add the sound effect.

In another example, a user may create touch correlated selections of entire audio or video files to create different playlists from a media library. For example, a first song may be linked to a one-finger touch, and a second song may be linked to a two-finger touch, up to five songs. Within a media player or other content presentation application, the user may cause the songs to be individually added to different playlists by performing an associated multi-finger touch gesture on the touch-sensitive user interface using the correlated number of fingers. For example, the user may select a position in each of one or more playlists at which the first song should be added, which may be performed by the user touching an “add song” GUI element or provide other touch input using one finger.

Another scenario in which multi-finger touch correlated selections may be used include, in a spreadsheet, performing copy-paste or cut-paste operations with respect to different non-contiguous rows, either within the same document or into a different target document. A further use of the multi-finger touch correlated selection capability includes performing copy-paste operations with respect to different files into multiple different file folders by linking each file to a different number of fingers.

Another scenario in which multi-finger touch correlated selections may be used involves planning a trip in a navigation application in which multiple available destination points are selected, each of which is linked to a different number of fingers (e.g., first destination linked to one finger, second destination linked to two fingers, etc.). A further use of the multi-finger touch correlated selection capability involves selecting a “share” or “send” option in a Bluetooth® application with respect to different files to be shared that are each linked to a different number of fingers.

In conventional content selection operations (e.g., cut or copy) a clipboard to be overwritten, such that it contains only the most recent buffer copied. That is, a previously written object is not stored in temporary memory, and cannot be used in a subsequent editing operation (e.g., paste) without repeating the selection.

The use of multi-finger touch correlated selections in various embodiments may mitigate such restraint. In some embodiments, the selection of a data object may involve copying or removing (i.e., cutting) the data object itself, while in other embodiments selection may involve copying or recording the object's location in memory or an identifier of the data object. In applications that involve copying or removing, the data object, separate data objects or groups thereof (i.e., content portions) may each be stored in separate buffers contained in individual clipboards. For example, a smartphone may be configured to store up to five or ten different clipboards associated with an editing function, which may be implemented by scratch pad memory.

In some embodiments, the buffers may be circular buffers that are implemented using scratchpad memory. The data within each buffer may be tracked using a head pointer and a tail pointer that point respectively to the beginning and end of the data. In various embodiments, each clipboard may be labeled with an index value representing a number of fingers for multi-finger touch input. For example, a one-finger touch correlated selection may be stored in a clipboard labeled with an index value of N=1, a two-finger touch correlated selection may be stored in a clipboard labeled with an index value of N=2, etc. When the user performs a multi-finger touch input in a content editing application or context, the data contained in the clipboard corresponding to the number of fingers contacting the touch-sensitive user interface may be used to perform the editing action. Each clipboard may be capable of storing a preset amount of data, which may include measurements in bytes (e.g., a number of kilobytes or megabytes), in content frames (e.g., video frames), in pixels (e.g., images), or other unit depending on the editing function(s) or content editing application(s) in which the clipboards are used.

The number of clipboards that are available for use for a particular editing function may depend on settings established by one or more content editing application, resource constraints of the mobile computing device, user preferences, and other factors. Specifically, since each clipboard implements an individual amount of writable space in memory, there is a trade-off between the amount of functionality supported (i.e., the number and size of clipboards) and the amount of available memory. In some embodiments, the size or number of clipboards may be restricted by the operating system or applications.

In some embodiments, multi-finger touch correlated selections may be created without requiring copying of the data objects by using clipboard registers. In particular, up to five or ten registers containing pointers and sizes of the data selections may be used instead of the individual clipboards. That is, some embodiments may copy or record the memory locations of data objects or groups thereof that are used as multi-finger touch correlated selections. For example, a first register may be maintained for one finger (N=1), a second register for two fingers (N=2), etc. The first clipboard register may contain a pointer to a location in general memory at which the data for a one-finger touch correlated selection starts, as well as the size of the data object(s) that constitute the selection. To perform an editing action, the content editing application or operating system may detect the number of fingers used for the touch input, identify the corresponding clipboard register, and use the entries to retrieve the correlated data in main memory. In this manner, the operating system or content editing application(s) may avoid reserving additional memory to enable creation of each touch correlated selection.

In another embodiment, using a number of fingers as a key, a hash function may be used to determine the location in memory at which the touch correlated selection is stored. Specifically, in response to receiving a multi-finger touch input, the content editing application(s) or operating system on the device may access a hash lookup table that has indexed the number of fingers, the data starting location, and the data size in order to locate the correlated data in main memory and perform the triggered editing action.

A multi-touch input may be used in any number of gestures on the touch-sensitive user interface, which may be interpreted to trigger an action based on the position on the display or the gesture itself. For example, the touch identification module may detect that a user has selected a content portion within a content editing application and/or has activated an editing menu prior to inputting a multi-finger touch gesture. In another example, the touch identification module may detect that user has input a multi-finger touch gesture to a particular position on the touch-sensitive user interface associated with an editing function (e.g., a particular GUI element). In various embodiments determining which touch correlated selection is invoked for an editing action may require determining the number of fingers in adjacent contact used to perform the gesture. The computing device may determine a number of adjacent fingers used to contact the touch-sensitive user interface by detecting the edges of the regions of contact, and determining whether edges of the regions are within a predetermined distance of each other. To detect the intended input location for a multi-finger touch gesture that uses two or more fingers, the device (e.g., the touch identification module or touch-sensitive user interface I/O controller) may identify a starting location that corresponds to a coordinate that is determined to be substantially at a center of the regions of the touch-sensitive user interface that are contacted by the fingers. While referred to herein as “adjacent fingers,” the fingers contacting the touch-sensitive user interface may be identified as adjacent regardless of whether they physically contact one another.

The properties of input to the touch-sensitive user interface may be determined by sensing/measuring data of a touch area associated with the user's finger(s) on the touch-sensitive user interface (i.e., “touch data”). In various embodiments, such touch data may include the location of points forming the boundary of the touch area, and a center of the touch area. In some embodiments, the properties derived from the touch data may include an ellipse function that best fits the boundary of the touch area, and which may be identified using a nonlinear regression analysis. In an example, the touch position of the user's finger may be represented by the center point of the touch area.

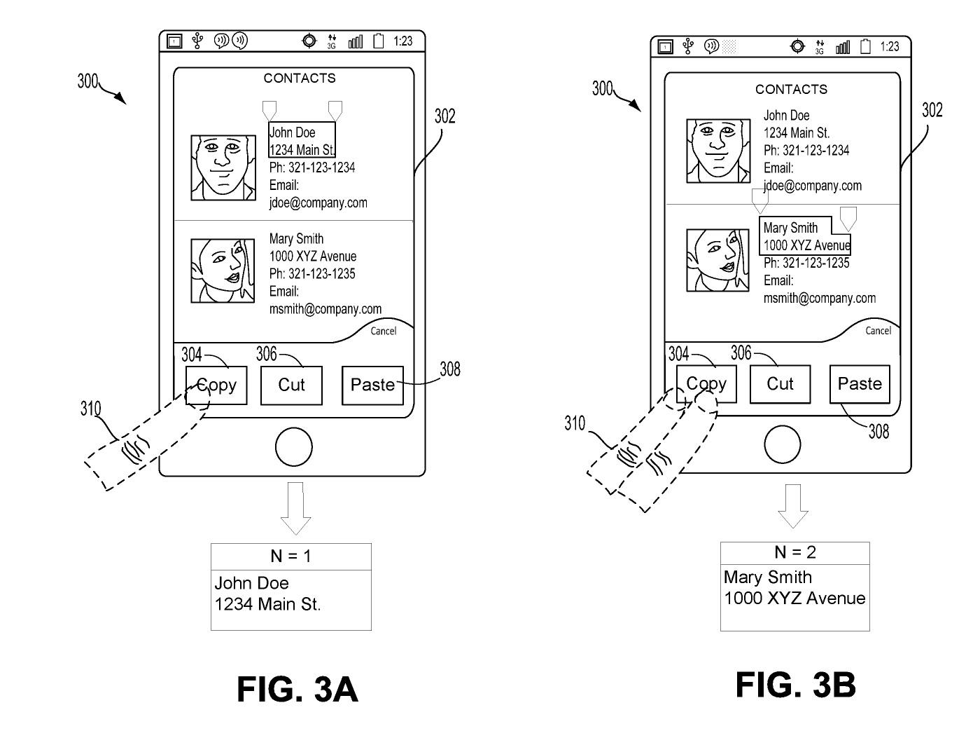

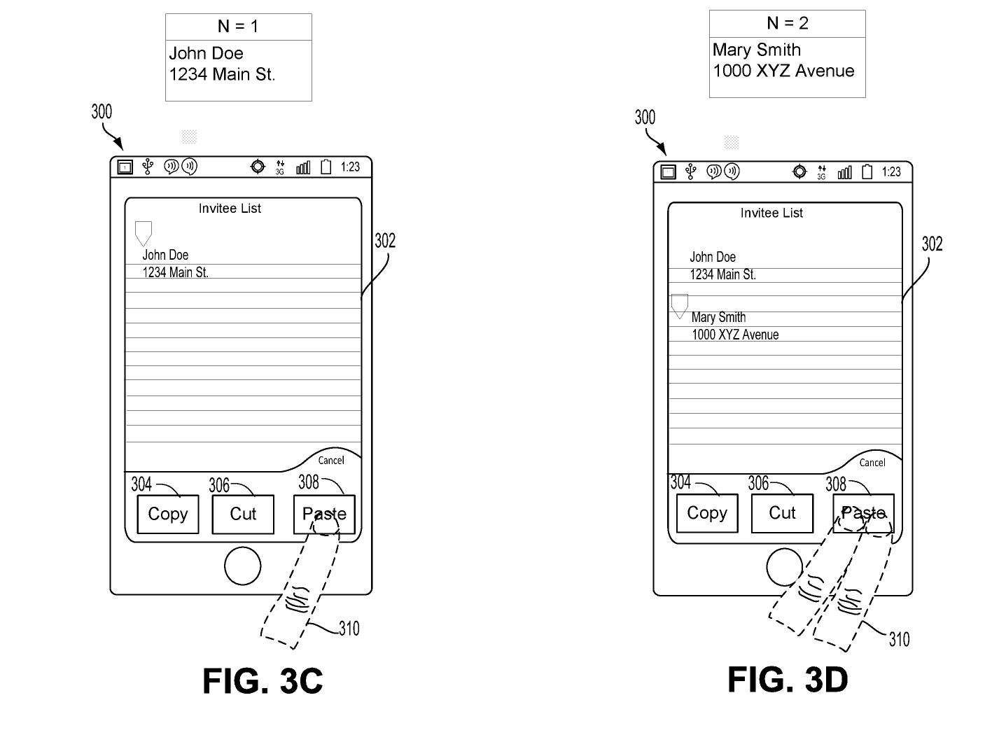

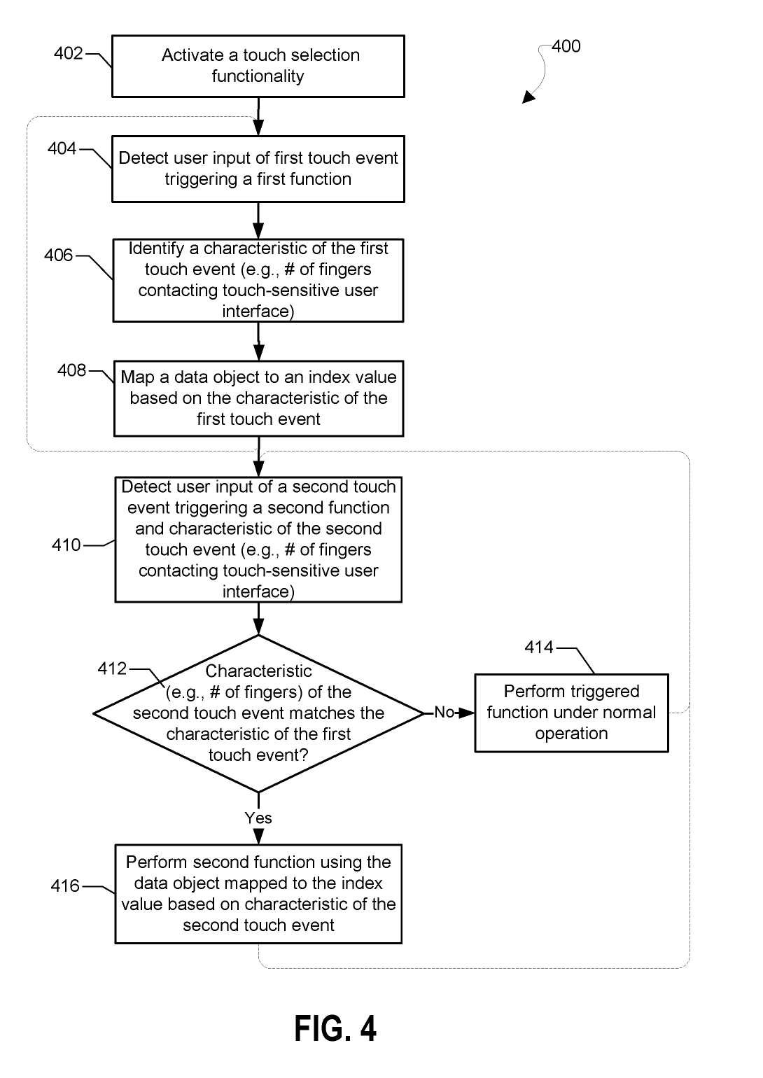

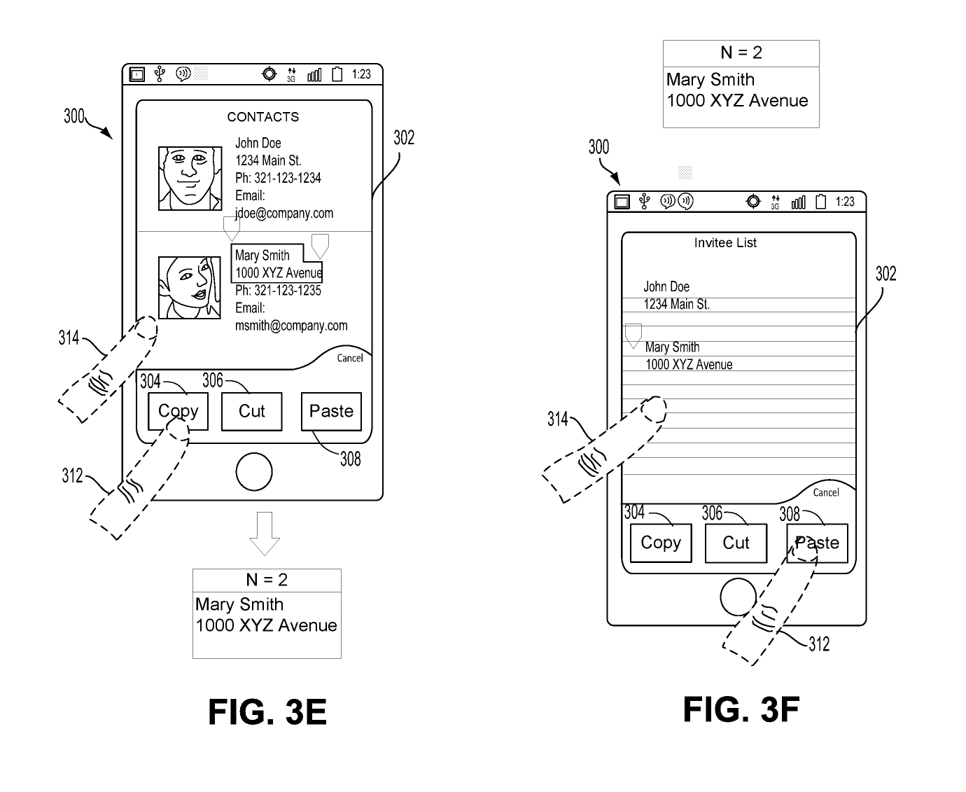

FIGS. 3A-3D are screenshots of a touchscreen display type of touch-sensitive user interface illustrating an example application of the multi-finger touch correlated selection capability on a mobile computing device 300 (which may correspond, for example, to the smartphone 100 and/or 200 in FIGS. 1-2). FIG. 3A shows a mobile computing device 300 running a directory application that stores and displays information about a user's contacts. The mobile communication device is configured with a touchscreen display 302. The directory application may be configured to utilize various editing functions that allow the user to manipulate text, including copy-paste and cut-paste mechanisms. To employ these functions, the user may activate an editing menu, for example, through a long press on the touchscreen, tapping an “Edit” icon, etc. The directory application may be configured to display a “Cut” element 304, a “Copy” element 306, a “Paste” element 308, and any other element or option to display additional elements within the editing menu on the touchscreen display 302. The element 304 may be selectable by the user's touch of the screen if the user has highlighted text, for example, using at least one finger 310, or alternatively, a stylus.

In the illustrated example, the user may be generating a list of persons and their addresses for mailing invitations to an event, and may utilize multi-finger touch selections from the directory application to facilitate this task. For example, the user may highlight the name and address fields for a contact John Doe, and use one finger 310 to select the element 304. The highlighted information for John Doe may be stored in a buffer within a first clipboard labeled N=1, thereby creating a one-finger touch correlated selection for John Doe's name and address. Within the same interface, the user may highlight the name and address fields for another contact Mary Smith, and use two fingers 310 to select the element 304, as shown in FIG. 3B. The highlighted information for Mary Smith may be stored in a buffer within a second clipboard labeled N=2, thereby creating a two-finger touch correlated selection for Mary Smith's name and address.

The user may open another application, such as a text editor, that is used to make an Invitee List, for example. The text editor may also be configured to utilize various editing operations, including copy-paste and cut-paste mechanisms. As shown in FIG. 3C, the user may activate an editing menu to enable use of these functions, such as through a long press on the touchscreen, tapping an “Edit” icon, etc., causing display of at least the elements 304-308. Upon detecting a one-finger touch input to the displayed element 308, the mobile computing device may retrieve the data object for N=1 to perform the corresponding “Paste” action—that is, the mobile computing device may retrieve the one-finger touch correlated selection from the first clipboard. As a result, the name and address information for John Doe may be added to the Invitee List at a location indicated by a cursor or other user designated location.

As shown in FIG. 3D, upon detecting a two-finger touch input to the displayed element 308 in the same interface, the mobile computing may retrieve the data object for N=2 to perform the corresponding “Paste” action—that is, the mobile computing device may retrieve the two-finger touch correlated selection from the second clipboard, causing the name and address information for Mary Smith to be added to the Invitee List.

While the content editing applications may perform the various multi-finger touch editing functions described herein, the processor may execute an application programming interface (API) layer that handles such functions. That is, the API layer may interface with any content editing applications in internal memory, thereby providing a consistent and universal touch editing platform.

FIG. 4 illustrates a method 400 for implementing a function on a data object based upon a characteristic of a touch event according to some embodiments. Referring to FIGS. 1-4, the operations of the method 400 may be implemented by one or more processors of the smartphone device (e.g., 100, 200), such as a general purpose processor (e.g., 202). In various embodiments, the operations of the method 400 may be implemented by a separate controller (not shown) that may be coupled to memory (e.g., 204), the touch-sensitive user interface (e.g., 212), and to the one or more processors (e.g., 110).

In block 402, the processor may activate a touch selection functionality on the smartphone or other computing device equipped with a multi-input touch-sensitive user interface, such as a touchscreen capable of recognizing multiple simultaneous finger touches. In some embodiments, activation of the touch selection functionality may be the result of a user input, such as launching an editing menu within a content editing application. In some embodiments, the touch selection functionality may be automatically activated based on the user's interaction with a particular type of functionality, such as a content editing application or in response to a user input highlighting selectable content within a content editing application.

In block 404, the processor may detect a user input as a first touch event on the touch-sensitive user interface (e.g., a touchscreen display, touch pad, or other type of touch-sensitive user interface) triggering a first function. For example, a touch-sensitive user interface I/O controller (e.g., 218) may provide signaling to the processor that contains information about the touch event (e.g., touch data coordinates, type of gesture, etc.), including a characteristic of the touch event, such as the number of fingers engaging the touch-sensitive user interface. In some embodiments, the first touch event of a user input may trigger or activate a function to be performed on a data object, such as storing a data object in memory (e.g., a copy or cut function). For example, the first touch event may copy into a buffer a portion of text from a document that has been highlighted by the user. In some embodiments, the first touch event of a user input may trigger or activate a functionality that selects or identifies a data object already stored in memory, such as a data subset selection function. For example, the first touch event may select a portion of a file (e.g., a video or audio clip) without storing redundant data, such as by storing a pointer to the starting point in the file of the selection and a pointer to a stopping point or a segment length of the selection, thereby enabling another editing function to use the selection (e.g., copying the selection into another file).

In block 406, the processor may identify a characteristic of the first touch event, such as the number of fingers contacting the touch-sensitive user interface during the first touch event. In some embodiments, the processor may identify the number of adjacent fingers contacting the touch-sensitive user interface during the first touch event. In some embodiments, the processor may identify other types of characteristics of the touch event (e.g., area, length, or width of the contact, shape of the contact, etc.) In some embodiments, such identification may be based on signaling from the touch-sensitive user interface I/O controller, and may be performed by one or more touch specialized module (e.g., touch identification module) that is run on the processor. In some embodiments, detecting the user input and identifying the characteristic of the touch event (e.g., identifying the number of fingers contacting the touch-sensitive user interface) may be performed in a single operation.

In block 408, the processor may correlate or map one or more data objects to an index value based on the identified characteristic of the first touch event (e.g., number of fingers contacting the touch-sensitive user interface). In some embodiments, the one or more data objects may be a defined by a user selection, such as a portion of text or other content that has been highlighted or otherwise chosen by the user in the content editing application. In some cases, the one or more data objects may also be stored in memory (e.g., a buffer) in block 408 consistent with the functionality activated by the first touch event. In some cases, the one or more data objects may already be stored in memory, so the functionality activated by the first touch event may involve storing or creating a pointer or other data structure for identifying the memory location(s) of the data objects, and mapping the one or more data objects to an index value associated with the identified characteristic of the first touch event (e.g., number of fingers) in block 408 may involve mapping the pointer or other data structure to the index value.

The operations in blocks 402-408 may be repeated for a number of times (e.g., up to 5 or 10 times) as the user performs operations (e.g., copies/cuts) on more data objects correlated or mapped to index values associated with the identified characteristics of the touch events, such as the number of fingers contacting the touch-sensitive user interface (e.g., a touch screen) during each of the first touch events.

In block 410, the processor may detect a second touch event triggering a different (“second”) function, and a characteristic of the touch event, such as the number of fingers contacting the touch-sensitive user interface in block 410. In some embodiments, the second function may be a function that is performed using, based on, or with respect to one or more data objects, such as an editing action that uses stored data objects. In some embodiments, detecting the touch event triggering the second function may involve detecting, in a content editing application, a user touch input on the touch-sensitive user interface launching an editing menu, which may be the same as or different from the editing menu for activation of touch selections in block 404. In some embodiments, detecting the touch event triggering the second function (e.g., an editing action) may be based on the location of the touch event on the touch-sensitive user interface in relation to GUI elements on a display (e.g., a touchscreen display), or based on the particular gesture that is detected (e.g., swipe, tapping, etc.) within the current content editing application. In some embodiments, the processor may also identify a characteristic of the touch event, such as the number of fingers contacting the touch-sensitive user interface in block 410.

In some embodiments, the content editing application may be the same as or different from the content editing application used for the touch selection. Within the same content editing application, the document or file on which the editing action is to be performed (e.g., target file) may be the same as or different from the file or document used in the touch selection (e.g., source file).

In determination block 412, the processor may determine whether the characteristic of the second touch event, such as the number of fingers contacting the touch-sensitive user interface (or other user interface) during the second touch event, matches the identified characteristic of the first touch event, such as the number of fingers contacting the touch-sensitive user interface (or other user interface) during the first touch event.

In response to determining that the characteristic of the second touch event, such as the number of fingers contacting the touch-sensitive user interface (or other user interface) during the second touch event, does not match the identified characteristic of the first touch event (i.e., determination block 412=“No”), the processor may perform the triggered function (e.g., an editing action) according to the normal operation of the action in block 414.

In response to determining that the characteristic of the second touch event, such as the number of adjacent fingers contacting the touch-sensitive user interface (or other user interface) during the second touch event, matches the identified characteristic of the first touch event (i.e., determination block 412=“Yes”), the processor may perform the triggered second function (e.g., an editing operation) using the one or more data objects mapped to the index value based on the characteristic of the second touch event, such as the number of fingers contacting the touch-sensitive user interface during the second touch event in block 416. For example, if the second touch event triggers an editing function using data objects, and the number of fingers touching the touch-sensitive user interface (or other user interface) matches or correlates to an index value previously mapped to one or more data objects, then the triggered editing function uses the corresponding one or more data objects (e.g., paste the corresponding data object(s) into the current file). As another example, if the editing function triggered by the second touch event detected in block 410 pastes a data object into a file, the number of fingers contacting the touch-sensitive user interface is determined to be 3, and the processor determines that a data object is mapped to an index value of 3 based on the first touch event in determination block 412, then that data object is used by the processor in executing the triggered editing function in block 416.

The operations in blocks 410 to 416 may be repeated any number of times to paste or apply data objects saved and correlated or mapped to index values in blocks 402-408. Thus, the various embodiments expand on data manipulation functions to allow users to select for storage (e.g., copy or cut) and for usage (e.g., paste) more than one data object while working in a given file by adjusting a characteristic of the touch event actuating a function, thereby improving upon and expanding the usefulness of common computing device functionality, such as editing functions.

Various embodiments have been described in relation to a smartphone device, but the references to a smartphone are merely to facilitate the descriptions of various embodiments and are not intended to limit the scope of the disclosure or the claims.

Various implementations of editing functions that use multi-finger touch correlated selections have been previously described in detail. It should be appreciated that the systems, as previously described, may be implemented as software, firmware, hardware, combinations thereof, etc. In one embodiment, the previous described functions may be implemented by one or more processors (e.g., processor(s) 110) of a smartphone device 100 to achieve the previously desired functions (e.g., the method operations of FIG. 400).

The teachings herein may be incorporated into (e.g., implemented within or performed by) a variety of apparatuses (e.g., devices). For example, one or more embodiments taught herein may be incorporated into a general device, a desktop computer, a mobile computer, a mobile device, a phone (e.g., a cellular phone), a personal data assistant, a tablet, a laptop computer, a tablet, an entertainment device (e.g., a music or video device), a headset (e.g., headphones, an earpiece, etc.), a medical device (e.g., a biometric sensor, a heart rate monitor, a pedometer, an electrocardiography “EKG” device, etc.), a user I/O device, a computer, a server, a point-of-sale device, an entertainment device, a set-top box, a wearable device (e.g., watch, head mounted display, virtual reality glasses, etc.), an electronic device within an automobile, or any other suitable device.

In some embodiments, a smartphone device may include an access device (e.g., a Wi-Fi access point) for a communication system. Such an access device may provide, for example, connectivity to another network through transceiver (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

It should be appreciated that when devices implementing the various embodiments are mobile or smartphone devices that such devices may communicate via one or more wireless communication links through a wireless network that are based on or otherwise support any suitable wireless communication technology. For example, in some embodiments the smartphone device and other devices may associate with a network including a wireless network. In some embodiments the network may include a body area network or a personal area network (e.g., an ultra-wideband network). In some embodiments the network may include a local area network or a wide area network. A smartphone device may support or otherwise use one or more of a variety of wireless communication technologies, protocols, or standards such as, for example, 3G, Long Term Evolution (LTE), LTE Advanced, 4G, Code-Division Multiple Access (CDMA), Time Division Multiple Access (TDMA), Orthogonal Frequency Division Multiplexing (OFDM), Orthogonal Frequency Division Multiple Access (OFDMA), WiMAX, and Wi-Fi. Similarly, a smartphone device may support or otherwise use one or more of a variety of corresponding modulation or multiplexing schemes. A smartphone device may thus include appropriate components (e.g., air interfaces) to establish and communicate via one or more wireless communication links using the above or other wireless communication technologies. For example, a device may include a wireless transceiver with associated transmitter and receiver components (e.g., a transmitter and a receiver) that may include various components (e.g., signal generators and signal processors) that facilitate communication over a wireless medium. As is well known, a smartphone device may therefore wirelessly communicate with other mobile devices, cell phones, other wired and wireless computers, Internet web-sites, etc.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, engines, circuits, and algorithm operations described in connection with the embodiments disclosed herein may be implemented as electronic hardware, computer software, or combinations of both. To clearly illustrate this interchangeability of hardware and software, various illustrative components, blocks, modules, engines, circuits, and operations have been described above generally in terms of their functionality. Whether such functionality is implemented as hardware or software depends upon the specific application and design constraints imposed on the overall system. Skilled artisans may implement the described functionality in varying ways for each application, but such implementation decisions should not be interpreted as causing a departure from the scope of the claims.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM, FLASH memory, ROM, Erasable Programmable Read Only Memory (EPROM), Electrically Erasable Programmable Read Only Memory (EEPROM), registers, hard disk, a removable disk, a Compact Disc Read Only Memory (CD-ROM), or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions or modules may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the principles and novel features disclosed herein.

What is claimed is:

1. A method implemented in a processor of a computing device having a touch-sensitive user interface, the method comprising:
detecting on the touch-sensitive user interface a characteristic of a first touch event of a user input triggering a first function to be performed on a data object;
mapping the data object to an index value based on the characteristic of the first touch event;
detecting on the touch-sensitive user interface the characteristic of a second touch event of a user input triggering a second function;
determining whether the characteristic of the second touch event matches the characteristic of the first touch event; and
performing the second function using the data object mapped to the index value based on the characteristic of the second touch event in response to determining that the characteristic of the second touch event matches the characteristic of the first touch event.

2. The method of claim 1, wherein:
the characteristic is a number of fingers touching the touch-sensitive user interface;
detecting on the touch-sensitive user interface a characteristic of a first touch event of a user input triggering a first function to be performed on a data object comprises detecting a first touch event of a user input that selects the data object, wherein the first function stores the selected data object in memory;
mapping the data object to an index value based on the characteristic of the first touch event comprises:
identifying a number of fingers contacting the touch-sensitive user interface during the first touch event; and
mapping the data object to an index value associated with the identified number of fingers contacting the touch-sensitive user interface during the first touch event; and
determining whether the characteristic of the second touch event matches the characteristic of the first touch event comprises determining whether a number of fingers contacting the touch-sensitive user interface during the second touch event matches the index value to which the data object is mapped.

3. The method of claim 1, wherein:
detecting on the touch-sensitive user interface the characteristic of a second touch event of a user input triggering a second function comprises detecting a user input triggering an editing action using a stored data object indexed to a number of fingers contacting the touch-sensitive user interface in the second touch event.

4. The method of claim 2, wherein:
identifying a number of fingers contacting the touch-sensitive user interface during the first touch event comprises identifying a number of adjacent fingers contacting the touch-sensitive user interface during the first touch event; and
determining whether a number of fingers contacting the touch-sensitive user interface during the second touch event matches the index value to which the data object is mapped comprises determining whether a number of adjacent fingers contacting the touch-sensitive user interface during the second touch event matches the index value to which the data object is mapped.

5. The method of claim 1, wherein performing the second function using the data object mapped to the index value based on the characteristic of the second touch event comprises:
accessing a buffer corresponding to the index value; and
retrieving the data object stored in the buffer.

6. The method of claim 1, wherein mapping the data object to an index value based on the characteristic of the first touch event on the touch-sensitive user interface comprises:
identifying a location in memory storing the data object; and
storing a pointer indicating a start of the location in memory and a size of the data object in a register corresponding to the index value.

7. The method of claim 6, wherein performing the second function using the data object mapped to the index value based on the characteristic of the second touch event comprises:
accessing the register corresponding to the index value; and
locating the data object in memory based on the pointer and size stored in the register corresponding to the index value.

8. The method of claim 1, further comprising activating a touch selection functionality in a content editing application in response to detecting a user input launching an editing menu in the content editing application.

9. The method of claim 1, wherein the data object is selected from a source file by a user, and wherein the triggered second function is performed on a target file that is different from the source file.

10. The method of claim 1, wherein performing the second function using the data object mapped to the index value based on the characteristic of the second touch event comprises:
identifying a triggered editing action based on the second touch event, wherein identification is based on at least one of a location on the touch-sensitive user interface relative to a graphical user interface (GUI) element and a gesture on the touch-sensitive user interface during the second touch event.

11. The method of claim 1, wherein when the triggered second function is an insert operation, and wherein performing the second function using the data object mapped to the index value based on the characteristic of the second touch event comprises adding the data object mapped to the index value to an existing file at a position indicated by the user.

12. The method of claim 1, wherein the data object comprises at least one of text, image data, video data, or audio data selected by a user.

13. A computing device, comprising:
a touch-sensitive user interface configured to function as a user interface;
a memory; and
a processor coupled to the touch-sensitive user interface and the memory, wherein the processor is configured with processor-executable instructions to perform operations comprising:
detecting on the touch-sensitive user interface a characteristic of a first touch event of a user input triggering a first function to be performed on a data object;
mapping the data object to an index value based on the characteristic of the first touch event;
detecting on the touch-sensitive user interface the characteristic of a second touch event of a user input triggering a second function;
determining whether the characteristic of the second touch event matches the characteristic of the first touch event; and
performing the second function using the data object mapped to the index value based on the characteristic of the second touch event in response to determining that the characteristic of the second touch event matches the characteristic of the first touch event.

14. The computing device of claim 13, wherein the processor is further configured with processor-executable instructions to perform operations such that:
the characteristic is a number of fingers touching the touch-sensitive user interface;
detecting on the touch-sensitive user interface a characteristic of a first touch event of a user input triggering a first function to be performed on a data object comprises detecting a first touch event of a user input that selects the data object, wherein the first function stores the selected data object in memory;
mapping the data object selected by the user to an index value based on the characteristic of the first touch event comprises:
identifying a number of fingers contacting the touch-sensitive user interface during the first touch event; and
mapping the data object to an index value associated with the identified number of fingers contacting the touch-sensitive user interface during the first touch event; and
determining whether the characteristic of the second touch event matches the characteristic of the first touch event comprises determining whether a number of fingers contacting the touch-sensitive user interface during the second touch event matches the index value to which the data object is mapped.

15. The computing device of claim 13, wherein the processor is further configured with processor-executable instructions to perform operations such that:
detecting on the touch-sensitive user interface the characteristic of a second touch event of a user input triggering a second function comprises detecting a user input triggering an editing action using a stored data object indexed to a number of fingers contacting the touch-sensitive user interface in the second touch event.

16. The computing device of claim 14, wherein the processor is further configured with processor-executable instructions to perform operations such that:
identifying a number of fingers contacting the touch-sensitive user interface during the first touch event comprises identifying a number of adjacent fingers contacting the touch-sensitive user interface during the first touch event; and
determining whether a number of fingers contacting the touch-sensitive user interface during the second touch event matches the index value to which the data object is mapped comprises determining whether a number of adjacent fingers contacting the touch-sensitive user interface during the second touch event matches the index value to which the data object is mapped.

17. The computing device of claim 13, wherein the processor is further configured with processor-executable instructions to perform operations such that performing the second function using the data object mapped to the index value based on the characteristic of the second touch event comprises:
accessing a buffer corresponding to the index value; and
retrieving the data object stored in the buffer.

18. The computing device of claim 13, wherein the processor is further configured with processor-executable instructions to perform operations such that mapping the data object to an index value based on the characteristic of the first touch event on the touch-sensitive user interface comprises:
identifying a location in memory storing the selected data object; and
storing a pointer indicating a start of the location in memory and a size of the data object in a register corresponding to the index value.

19. The computing device of claim 18, wherein the processor is further configured with processor-executable instructions to perform operations such that performing the second function using the data object mapped to the index value based on the characteristic of the second touch event comprises:
accessing the register corresponding to the index value; and
locating the data object in memory based on the pointer and size stored in the register corresponding to the index value.

20. The computing device of claim 13, wherein the processor is further configured with processor-executable instructions to perform operations further comprising activating a touch selection functionality in a content editing application in response to detecting a user input launching an editing menu in the content editing application.

21. The computing device of claim 13, wherein the processor is further configured with processor-executable instructions to perform operations such that the data object is selected from a source file by a user, and wherein the triggered second function is performed on a target file that is different from the source file.

22. The computing device of claim 13, wherein the processor is further configured with processor-executable instructions to perform operations such that performing the second function using the data object mapped to the index value based on the characteristic of the second touch event comprises:
identifying a triggered editing action based on the second touch event, wherein identification is based on at least one of a location on the touch-sensitive user interface relative to a graphical user interface (GUI) element and a gesture on the touch-sensitive user interface during the second touch event.

23. The computing device of claim 13, wherein the processor is further configured with processor-executable instructions to perform operations such that when the triggered second function is an insert operation, performing the second function using the data object mapped to the index value based on the characteristic of the second touch event comprises adding the data object mapped to the index value to an existing file at a position indicated by the user.

24. The computing device of claim 13, wherein the data object comprises at least one of text, image data, video data, or audio data selected by the user.

25. A computing device, comprising:
a touch-sensitive user interface configured to function as a user interface;
means for detecting on the touch-sensitive user interface a characteristic of a first touch event of a user input triggering a first function to be performed on a data object;
means for mapping the data object to an index value based on the characteristic of the first touch event;
means for detecting on the touch-sensitive user interface the characteristic of a second touch event of a user input triggering a second function;
means for determining whether the characteristic of the second touch event matches the characteristic of the first touch event; and
means for performing the second function using the data object mapped to the index value based on the characteristic of the second touch event in response to determining that the characteristic of the second touch event matches the characteristic of the first touch event.

26. The computing device of claim 25, wherein:
the characteristic is a number of fingers touching the touch-sensitive user interface;
means for detecting on the touch-sensitive user interface a characteristic of a first touch event of a user input triggering a first function to be performed on a data object comprises means for detecting a first touch event of a user input that selects the data object, wherein the first function stores the selected data object in memory;
means for mapping the data object to an index value based on the characteristic of the first touch event comprises:
means for identifying a number of fingers contacting the touch-sensitive user interface during the first touch event; and
means for mapping the data object to an index value associated with the identified number of fingers contacting the touch-sensitive user interface during the first touch event; and
means for determining whether the characteristic of the second touch event matches the characteristic of the first touch event comprises means for determining whether a number of fingers contacting the touch-sensitive user interface during the second touch event matches the index value to which the data object is mapped.

27. The computing device of claim 25, wherein:
means for detecting on the touch-sensitive user interface the characteristic of a second touch event of a user input triggering a second function comprises means for detecting a user input triggering an editing action using a stored data object indexed to a number of fingers contacting the touch-sensitive user interface in the second touch event.

28. A non-transitory processor-readable storage medium having stored thereon processor-executable instructions configured to cause a processor of a computing device having a touch-sensitive user interface to perform operations comprising:
detecting on the touch-sensitive user interface a characteristic of a first touch event of a user input triggering a first function to be performed on a data object;
mapping the data object to an index value based on the characteristic of the first touch event;
detecting on the touch-sensitive user interface the characteristic of a second touch event of a user input triggering a second function;
determining whether the characteristic of the second touch event matches the characteristic of the first touch event; and
performing the second function using the data object mapped to the index value based on the characteristic of the second touch event in response to determining that the characteristic of the second touch event matches the characteristic of the first touch event.

29. The non-transitory processor-readable medium of claim 28, wherein the stored processor-executable instructions are configured to cause a processor to perform operations such that:
the characteristic is a number of fingers touching the touch-sensitive user interface;
detecting on the touch-sensitive user interface a characteristic of a first touch event of a user input triggering a first function to be performed on a data object comprises detecting a first touch event of a user input that selects the data object, wherein the first function stores the selected data object in memory;
mapping the data object to an index value based on the characteristic of the first touch event comprises:
identifying a number of fingers contacting the touch-sensitive user interface during the first touch event; and
mapping the data object to an index value associated with the identified number of fingers contacting the touch-sensitive user interface during the first touch event; and
determining whether the characteristic of the second touch event matches the characteristic of the first touch event comprises determining whether a number of fingers contacting the touch-sensitive user interface during the second touch event matches the index value to which the data object is mapped.

30. The non-transitory processor-readable medium of claim 28, wherein the stored processor-executable instructions are configured to cause a processor to perform operations such that:
detecting on the touch-sensitive user interface the characteristic of a second touch event of a user input triggering a second function comprises detecting a user input triggering an editing action using a stored data object indexed to a number of fingers contacting the touch-sensitive user interface in the second touch event.
